(19) United States
(12) Patent Application Publication
(10) Pub. No.: US 2005/0008255 A1
(43) Pub. Date: Jan. 13, 2005

(54) Image generation of high quality image from low quality images

(76) Inventor: Seiji Aiso, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/821,651

(22) Filed: Apr. 9, 2004

(30) Foreign Application Priority Data
Apr. 15, 2003 (JP) 2003-109754
Mar. 31, 2004 (JP) 2004-102167

(51) Int. Cl. G06K 9/36; G06K 9/32

(52) U.S. Cl. 382/284; 382/294

(57) ABSTRACT

An image-generating range is set so that an image of higher quality are generated when an image of high pixel density is generated from a plurality of images with lower pixel density. Data on a plurality of frame images each of which includes a portion of the same recorded subject are prepared (See S2). The density of the pixels forming the plurality of frame images is relatively low. The relative positions between the images in the data on the plurality of frame images are calculated (See S4) based on the portions of the same recorded subject. An image generation area included in areas where the image from the data on the plurality of frame images has been recorded, which is an area for generating an image in which the density of pixels forming the image is relatively higher, is then determined (See S6) based on the relative positions between the images from the data on the plurality of frame images. An image is then generated (See S8) in the image generation area from the images of the data on the plurality of frame images.

### BACKGROUND OF THE INVENTION

1. Field of the Invention

The present invention relates to a technique for generating an image of high pixel density from a plurality of low pixel density images, and in particular to a technique for establishing an area for generating the image so that the resulting image is of higher quality.

2. Description of the Related Art

Conventional methods are available for synthesizing still an image of high pixel density from a plurality of frames of low pixel density motion images. Japanese Unexamined Patent Application (Kokai) 11-164264, for example, discloses a technique as follows. From a plurality of frame images for a device such as a CRT on which images are displayed by repeated scanning in the horizontal direction, a new image with a density greater than the density of the scanning lines of frame images in the vertical direction is generated.

However, there are no techniques for determining an image generation area resulting in an image of higher quality when generating an image of high pixel density from a plurality of images having low pixel density.

An object of the present invention, which was undertaken to address the above drawbacks in the prior art, is to determine an image generation area resulting in an image of higher quality when generating an image of high pixel density from a plurality of images having low pixel density.

### SUMMARY OF THE INVENTION

In order to address at least some of the above objects, the present invention employs the following process when generating an image of high pixel density from a plurality of images having low pixel density. First, a plurality of first images each of which includes a portion where a same recorded subject is recorded are prepared. An image generation area for generating a second image in which a density of pixels forming image is higher than that of the first images is determined, based on a overlap between the plurality of first images. Then the second image in the image generation area is generated from the plurality of first images.

In the above aspect, the area which is included in many images among the plurality of the first images redundantly can be set as the image generation area. It is thus possible to determine an image generation area resulting in an image of higher quality when generating an image of high pixel density from a plurality of images having low pixel density.

The following is preferred when determining the image generation area. The determination of the image generation area is executed so that an overlapping index value representing an extent of overlap between the plurality of first images and the image generation area is closest to a predetermined target level on a predetermined condition. In this aspect, the target level can be adjusted in order to determine an image generation area so that the evaluation of image generation area other than the extent of overlapping with the plurality of first images, e.g. the breadth of the image generation area, does not become poor.

The following is preferred when determining the image generation area. That is, a plurality of candidate areas included in a sum area which is sum of areas in which first images are recorded are first prepared. One of the candidate areas is selected as the image generation area from among the plurality of candidate areas, based on an evaluation value for each of the candidate areas which is determined based on overlaps between the plurality of first images and the candidate area. In this aspect, the image generation area can be selected from among limited candidates based on the evaluation value. An image generation area can thus be simply selected.

When selecting the candidate area, it is preferable to determine the evaluation values for the candidate areas based on relative positions between the candidate areas and the first images.

When selecting the candidate area, it is preferable to determine the evaluation value for each of the candidate areas. In the determination of the evaluation value for one of the candidate areas, the following is preferred. That is, an evaluation target portion is determined. The evaluation target portion is a portion of a profile of a target candidate area for which the evaluation value is being determined and included in an area of one of the plurality of first images. Then the evaluation value for the target candidate area is determined based on lengths of the evaluation target portions for the plurality of first images. In this aspect, an image generation area can be determined on the basis of simple calculations so as to result in an image of higher quality.

When selecting the candidate area, the following embodiment may be employed. That is, sample points are set on a profile of each of the candidate areas. Then the evaluation values are determined for the candidate areas based on the sample points. In the determination of the evaluation value for one of candidate areas, the following is preferred. Evaluation sample points are determined among the sample points of a target candidate area for which the evaluation value is being determined. The evaluation sample points are sample points included in an area of one of the plurality of first images. The evaluation sample points of the plurality of first images are determined. Then the evaluation value is determined for the target candidate area based on a number of the evaluation sample points of the plurality of first images. This aspect also allows an image generation area to be determined on the basis of simple calculations so as to result in an image of higher quality.

When selecting the candidate area, the following embodiment may also be employed. Sample points are set on a profile of each of the first images. Then the evaluation values are determined for the candidate areas based on the sample points. In the determination of the evaluation value for one of candidate areas comprises, the following is preferable. That is, evaluation sample points are determined among the sample points of one of the first images. The evaluation sample points are sample points included in a target candidate area for which the evaluation value is being determined. Then the evaluation value is determined for the target candidate area based on numbers of the evaluation sample points of the plurality of first images. This aspect also allows candidate areas comprising an area of images including many overlapping first images to be selected as the image generation area based on simple calculations.

When selecting the candidate area, following procedure may be executed. That is, evaluation areas having a certain width near profiles of the candidate areas are set. Then the evaluation values are determined for the candidate areas based on the evaluation areas. In the determination of the evaluation value for one of candidate areas the following is preferable. A limited evaluation area is determined. The limited evaluation area is a portion of a target candidate area for which the evaluation values is being determined and is included in an area of one of the plurality of first images. Then a total number of pixels included in the limited evaluation area of the plurality of first images is calculated. The evaluation value is determined for the target candidate area based on total number of the pixels.

When selecting the candidate area, following procedure may also be executed. That is, sample points are set near profiles of the candidate areas. Then the evaluation values for the candidate areas are determined based on the sample points. In the determination of the evaluation value for one of candidate areas, the following is preferable. Evaluation sample points are determined among the sample points of a target candidate area for which the evaluation value is being determined. The evaluation sample points are sample points included in an area of one of the plurality of first images. Then the evaluation value for the target candidate is determined based on a number of evaluation sample points for the plurality of first images.

The following is also preferable. At least one of the plurality of first images is output through an output device. The second image is output through the output device in a same size as the first image output. In this aspect, user can compare the areas of the first and second images easily.

In order to address at least some of the above objects, the following process can be employed when generating an image of high pixel density from a plurality of images having low pixel density. First, a plurality of the first images comprising portions of the same recorded subject, where the density of the pixels forming the images is relatively low, is prepared. The relative positions between the plurality of the first images are calculated based on the portions of the same recorded subject. An image generation area is then determined on the basis of the relative positions between the plurality of first images. The image generation area is an area for generating a second image where the density of the pixels forming the image is relatively higher. The image generation area is to be included in a sum area comprising all the areas in which first images are recorded. In this aspect, the area of images comprising several overlapping first images among the plurality of first images can be set as the image generation area. An image generation area can thus be determined so as to result in an image of higher quality.

In the determination based on the relative positions between the plurality of first images, the following is executed. First, a plurality of candidate areas included in the sum area comprising all the areas in which first images are recorded are first prepared. One of the candidate areas is then selected as the image generation area from among the plurality of candidate areas, based on an evaluation of each candidate area determined on the basis of the relative positions between the first images and the candidate areas. In this aspect, the image generation area can be simply selected based on the relative positions between the plurality of first images that have been prepared.

When selecting the candidate area, it is preferable to determine the evaluation value based on numbers of pixels in the first images included in portions where the candidate area and the first images overlap. In this aspect, candidate areas including an area of images comprising many overlapping first images can be selected as the image generation area. An image generation area can thus be determined so as to result in an image of higher quality.

When selecting candidate areas, evaluation values may be determined on the basis of the length of the portions in the first image areas among the profile of the candidate areas. In this aspect, candidate areas comprising an area of images including many overlapping first images can be selected as the image generation area based on simpler calculations. That is, an image generation area can be determined based on simpler calculations so as to result in an image of higher quality.

The evaluation values may also be determined based on the number of sample points included in the first image areas among the sample points set on the profile of the candidate areas when selecting candidate areas. In this aspect, candidate areas comprising an area of images including many overlapping first images can be selected as the image generation area based on even simpler calculations. That is, an image generation area can be determined on the basis of even simpler calculations so as to result in an image of higher quality.

Evaluation values may also be determined on the basis of the number of sample points included in the candidate areas among the sample points set on the profile of the first images when selecting candidate areas. This aspect also allows candidate areas comprising an area of images including many overlapping first images to be selected as the image generation area based on simple calculations.

When selecting candidate areas, the evaluation values may also be determined on the basis of the number of first image pixels included in portions in the first image areas among the evaluation areas near the profile of the candidate areas.

Another aspect when selecting candidate areas is to determine the evaluation values based on the number of sample points included in the first image areas among the set sample points near the profile of the candidate areas.

The following procedure is preferred when preparing the plurality of candidate areas. That is, a first candidate area included in the sum area being sum of areas in which first images are recorded is set first. Then a second candidate area and a third candidate area are prepared. The second candidate area is an area included in the sum area being sum of areas in which first images are recorded, and is to conform to the first candidate area by being displaced a certain extent in a first direction. The third candidate area is an area included in the sum area being sum of areas in which first images are recorded, and is to conform to the first candidate area by being displaced a certain extent in a direction opposite the first direction. In this aspect, the image generation area can be selected from among a plurality of candidate areas set in a certain range based on a first candidate area.

The following procedure is preferred when preparing the plurality of candidate areas. First, a first candidate area included in the sum area being sum of areas in which first images are recorded is set. Then a second candidate area and a third candidate area are prepared. The second candidate area is an area included in the sum area being sum of areas in which first images are recorded, and is to conform to the first candidate area by being shrunk around a certain fixed point. The third candidate area is an area included in the sum area being sum of areas in which first images are recorded, and is to conform to the first candidate area by being magnified around a certain fixed point. This aspect allows the image generation area to be selected from prepared candidate areas that are larger or smaller than the first candidate area. The first candidate area is preferably indicated by the user.

The tone levels of the pixels in the second image may be calculated by the following procedure when generating a second image in cases where the pixels of the plurality of first images have varying tone levels. First, from pixels of the second image, a target pixel for calculating the tone level is selected. From the pixels of the plurality of first images, a plurality of specified pixels are selected. The specified pixels are pixels located in a certain range near the target pixel when the pixels of the plurality of first images are supposed to be arranged according to the relative positions and pixels of the second image are furthermore supposed to be arranged in the image generation area. Then tone level of the target pixel is calculated based on a weighted average of tone levels of the specified pixels. This aspect allows the tone levels of the pixels in an image of higher pixel density to be calculated from the tone levels of pixels in images of low pixel density.

Specified pixels preferably include pixels closest to the target pixels among the plurality of first images when the pixels of the plurality of first images are arranged according to the relative positions and the second image pixels are furthermore arranged in the image generation area. Specified pixels may preferably be pixels included within a circle having a radius twice as long as the pitch of the first image pixels and the center identical with the target pixel when the pixels of the plurality of first images are arranged according to the relative positions and the second image pixels are furthermore arranged in the image generation area.

The present invention can also be realized in the various aspects below.

(1) Image-generating methods, image-processing methods, and image data-generating methods.

(2) Image generators, image processors, image data generators.

(3) Computer programs for running the above devices and methods.

(4) Recording media for recording computer programs for running the above devices and methods.

(5) Data signals embodied in carrier waves and comprising computer programs for running the above devices and methods.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a schematic illustration of the structure of an image generator in an embodiment of the invention;

FIG. 2 is a flow chart of the procedures for generating still image data representing a still image from a plurality of frame images of motion picture data;

FIG. 3 illustrates a user interface display screen for designating the instant in time for which a high resolution still image is desired by the user during motion picture playback;

FIG. 4 illustrates a method for specifying the relative positions in the frame image data;

FIG. 5 illustrates relative positions in five frames of image data F1 through F5;

FIG. 6 is a flow chart of a procedure for determining an area in which still image data is generated in Step S6 in FIG. 2;

FIG. 7 illustrates candidate areas Ac1 to Ac12;

FIG. 8 illustrates the relative position between candidate areas Ac0 to Ac12 and an area Fa which is an area comprising all the areas in which frame image data F1 to F5 are recorded;

FIG. 9 illustrates the relationship between sample points Pe of candidate area Ac0 and the frame image data F1 through F5;

FIG. 10 illustrates the number Nᵢⱼₖ of sample points in the frame image data for candidate area Ac0, the evaluation values Sₒⱼ of each side of the candidate area Ac0, and the evaluation value E₀ of candidate area Ac0;

FIG. 11 illustrates the relationship between image generation area Ad and portions in which the frame image data F1 through F5 overlap;

FIG. 12 illustrates a method for synthesizing an image of high pixel density from a plurality of images of low pixel density;

FIG. 13 is a flow chart of a procedure for determining the RGB tone levels for each pixel in an image of still image data based on the RGB tone levels for each pixel in the images of the frame image data;

FIG. 14 illustrates an evaluation area Ae0 which is set inside candidate area Ac0 and near the perimeter of candidate area Ac0 in a certain width;

FIG. 15 illustrates the length Lc₀₁ of a portion contained in the area of the frame image data F1 within the four sides of candidate area Ac0;

FIG. 16 illustrates sample points Pe1 through Pe5 set on the side of the image area of frame image data F1 through F5;

FIG. 17 is a schematic illustration of the structure of an image generator in Embodiment 5;

FIG. 18 is a flow chart of a procedure for generating still image data representing a still image from a plurality of frame images in motion picture data in Embodiment 5; and

FIG. 19 is an illustration of a user interface display screen displayed on a display 110 in Step S10 in FIG. 18.

### DETAILED DESCRIPTION OF PREFERRED EMBODIMENTS

The embodiments below illustrate the invention in the following order.

A. Embodiment 1
A-1: Structure of Device
A-2: Overall Procedure for Generating Still Image Data
A-3: Determination of Image Generation Area
A-4: Generation of Still Image Data

B. Embodiment 2

C. Embodiment 3

D: Embodiment 4

E: Embodiment 5

F: Variants

A. Embodiment 1

A-1: Structure of Device

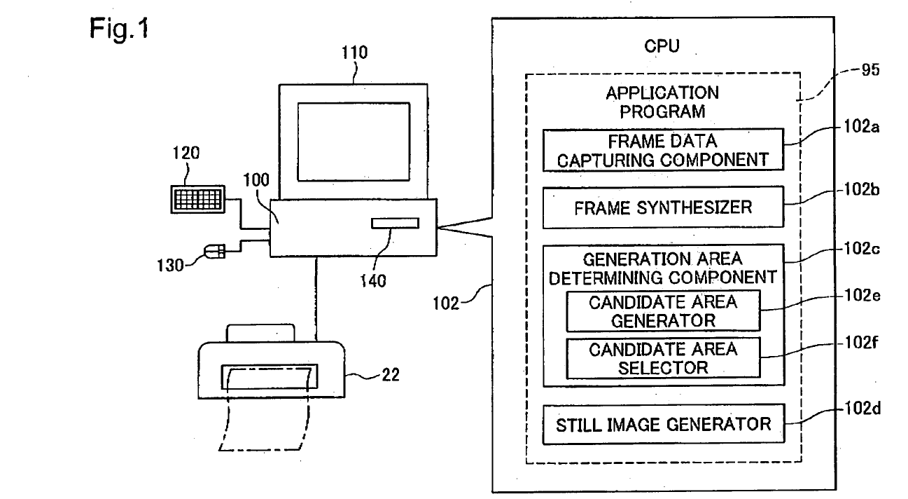

FIG. 1 is a schematic illustration of the structure of an image generator in an embodiment of the invention. The image generator comprises a personal computer 100 for running certain image processing on the image data, a keyboard 120, a mouse 130 and CD-R/RW drive 140 as devices for inputting data to the personal computer 100, and a display 110 and printer 22 as devices for outputting data. An application program 95 is operated under the control of a certain operating system in the computer 100. The application program 95 is run to allow the CPU 102 of the computer 100 to execute various functions.

When an application program 95 for retouching images or the like is run and the user inputs commands via the keyboard 120 or mouse 130, the CPU 102 reads image data into memory from the CD-RW in the CD-R/RW drive 140. The CPU 102 runs a certain image process on the image data and displays an image through a video driver on the display 110. The CPU 102 can print the processed image data via a printer driver to a printer 22.

Image data comprising motion pictures includes a plurality of frame image data, each of which represents a still image. The plurality of frame image data is consecutively numbered, and the still image of each frame image data is displayed on the display 110 according to the consecutive sequence to playback the motion pictures on the display 110.

A-2: Overall Procedure for Generating Still Image Data

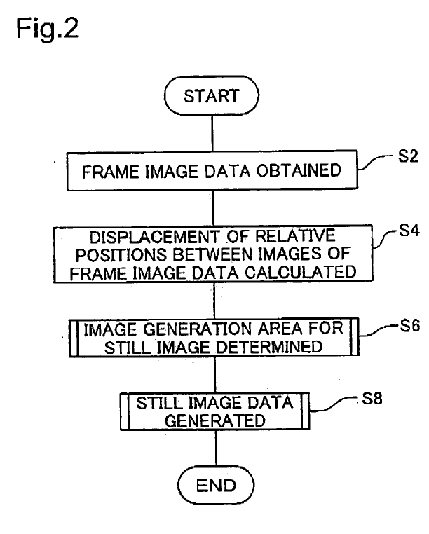

FIG. 2 is a flow chart of the procedure for generating still image data representing the still images from the plurality of frame images in the motion picture data. In Step S2, when the application program 95 is run and the user inputs commands by way of the keyboard 120 or mouse 130, the CPU 102 first obtains five continuous frames of image data from the image data representing the motion pictures stored in memory.

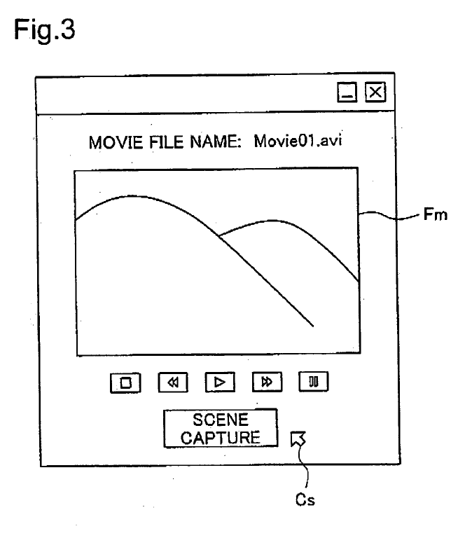

FIG. 3 illustrates a user interface display screen for designating the instant in time for which a high resolution still image is desired by the user during motion picture playback. For example, the CPU 102 reads certain motion picture data from the CD-RW (movie file Movie.avi in the example in FIG. 3) and stores it in memory based on user commands input by the keyboard 120 or mouse 130 to the computer 100. As illustrated in FIG. 3, the motion picture Fm of the image data is played back on the display 110. In Step S2, when the motion picture is played back on the display 110, the user moves the cursor Cs via the mouse 130 and presses the “scene capture” button in the user interface display screen to designate a specific instant during motion picture playback. The keyboard 120 can also be used to designate the specific instant during motion picture playback.

When the user designates the specific instant during motion picture playback, the CPU 102 obtains the frame image data F3 displayed on the display 110 at that instant, the previous two frames of motion picture data F1 and F2, and the next two frames of image data F4 and F5. In this way, the function of obtaining a plurality of frames of image data as instructed by the user is executed by a frame data capturing component 102a (see FIG. 1) which is a functional component of the CPU 102.

Let us assume that the motion picture data read from the CD-RW and stored in memory is motion picture data with a 3:4 aspect ratio, and that the motion picture data is of a still object, such as a landscape or still life, which is slightly swayed by the hand movements of the individual taking the picture. The subject will therefore be the same in the still pictures represented by each of the five frames of image data selected in Step S2, but the position of the photographed subject in the images will be slightly displaced.

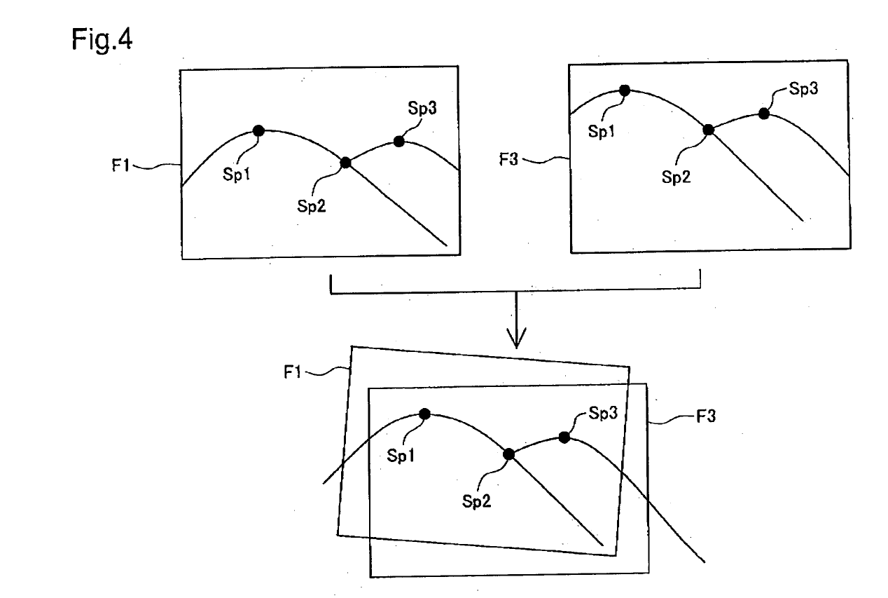

FIG. 4 illustrates a method for specifying the relative positions in the frame image data. In Step S4 in FIG. 2, the displacement of the relative positions between the images in the five frames of image data read in Step S2 is calculated. The relative positional displacement of the images in the frames of image data is determined in the following manner.

First, characteristic points are determined in the portions where the same image is recorded in the images. In FIG. 4, the characteristic points are represented by the black solid circles Sp1 through Sp3 in the frames of image data F1 and F3. In FIG. 4, two mountains and the sky are the same subject in the frames of image data F1 and F3. The characteristic points are located at characteristic image sections which do not frequently appear in common images. As illustrated in FIG. 4, for example, the mountain peaks (Sp1 and Sp3) or the point where the profiles of the mountains intersect (Sp2) can be used.

Then, as illustrated in the bottom drawing in FIG. 4, the relative positional displacement between the images in the frames of image data F1 and F3 is specified and calculated by determining the relative positions between the images in the frames of image data so that the characteristic points Sp1 through Sp3 in the frames of image data F1 and F3 overlap.

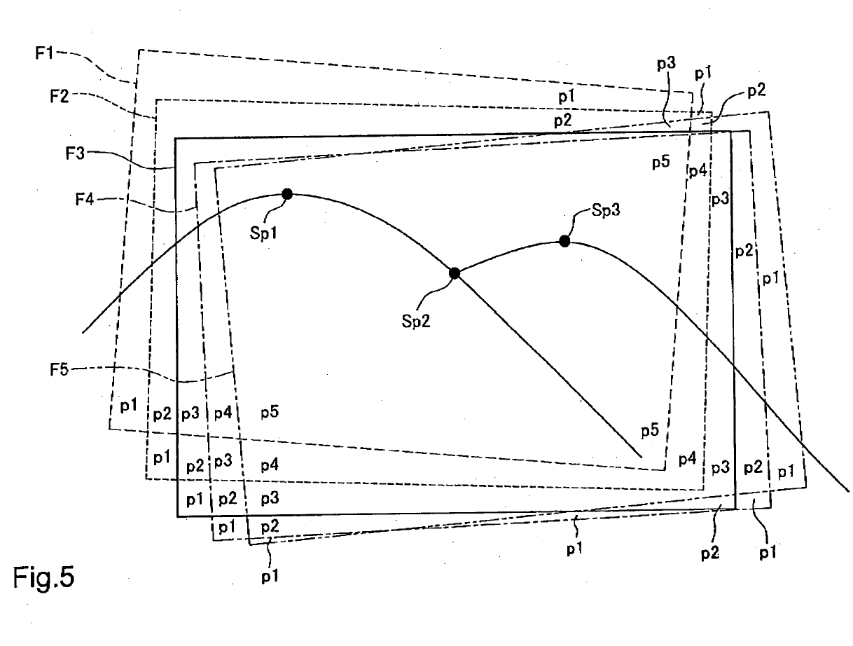

FIG. 5 illustrates relative positions in five frames of image data F1 through F5. When the relative positional displacement between the five frames of image data F1 through F5 is calculated in Step S4, the relative positions between the frames of image data F1 through F5 are specified as illustrated in FIG. 5. In the image illustrated in FIG. 5, p5 represents the portion where the same images is recorded when all five frames of image data F1 through F5 over lap. The symbols p2 through p4 indicate where the same image is recorded when two to four frames of image data overlap. The symbol p1 indicates where only one frame of image data is recorded.

The function of specifying the relative positions between the images in the plurality of frames of image data based on the characteristic points is managed by a frame synthesizer 102b, which is a functional component of the CPU 102. The displacement of the relative positions between the frames of image data F1 through F5 in FIG. 5 has been exaggerated for the convenience of explanation. That is, FIG. 5 does not reflect the actual extent of displacement between the images in the motion picture frames.

In Step S6 of FIG. 2, it is determined that which portion in the images represented by the frames of motion picture data F1 through F5 will be used to generate a still image. The image to be generated, represented by still image data, has the same rectangular aspect ratio of 3:4 as the images of the motion picture data. The pixel density of the image of the still image data to be generated is four times greater than the vertical and horizontal pixel density of the images in the frames of motion picture data F1 through F5. The image area where the still image data is generated is referred to as the “image generation area.” The function of determining the image generation area where the still image data is generated is managed by an image generation determining component 102c (see FIG. 1) which is a functional component of the CPU 102.

Then, in Step S8, the still image data is generated for the area determined in Step S6. The function of generating the still image data is managed by a still image generator 102d (see FIG. 1) which is a functional component of the CPU 102. The procedure for determining the image generation area in Step S6 and generating the still image data in Step S8 is described below.

A-3: Determination of Image Generation Area

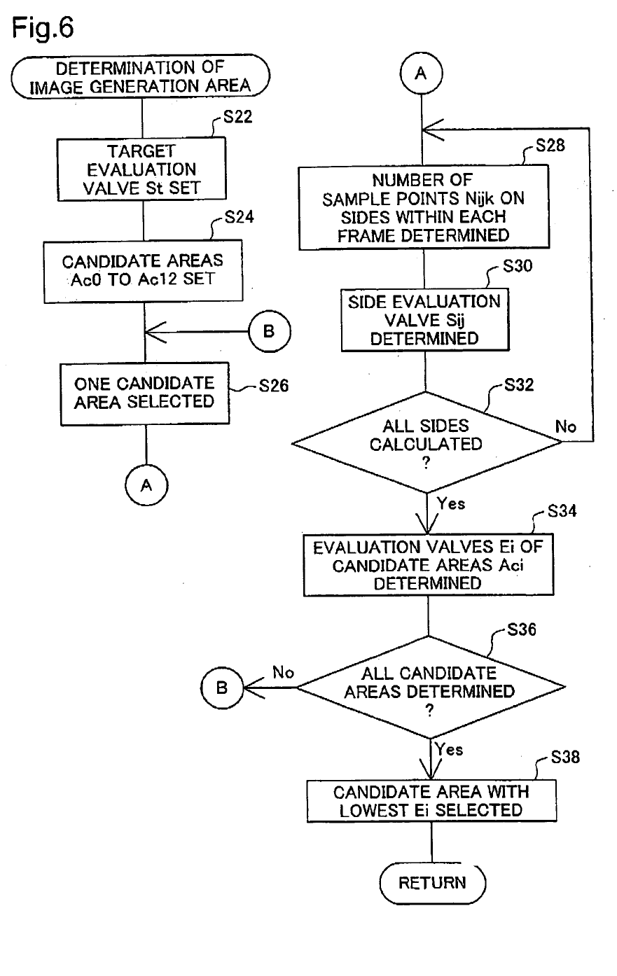

FIG. 6 is a flow chart of a procedure for determining an area in which still image data is generated in Step S6 in FIG. 2. In Step S22, a target evaluation value St is first set. St is any number from 1 to 5. The target evaluation value St can be any value from 1 to the “number of frames of image data obtained in Step S2.” The greater the target evaluation value St, the greater the possibility of generating a still image with greater resolution but also the greater possibility of a smaller image generation area. The target evaluation value St is described below.

The target evaluation value St may be a pre-determined value such as 4 or 3, or the user may input a level to the computer 100 through the mouse 130 or keyboard 120. When the user sets the target evaluation value St, the user can control the balance between the resolution and the size of the image generation area of the still image that is produced by adjusting the target evaluation value St.

In Step S24, candidate areas Ac0 through Ac12 which are candidates for the image generation area are set. The function of generating the candidate area is managed by a candidate area generator 102e (see FIG. 1) which is a functional component of the CPU 102. The candidate area generator 102e is a functional component constituting a part of the generation area determining component 102c which is a functional component of the CPU 102.

In Step S24, candidate area Ac0 is first set. The candidate area Ac0 is equivalent to the area of the image in frame image data F3 (see FIG. 5). The aspect ratio of the candidate area Ac0 is 3:4.

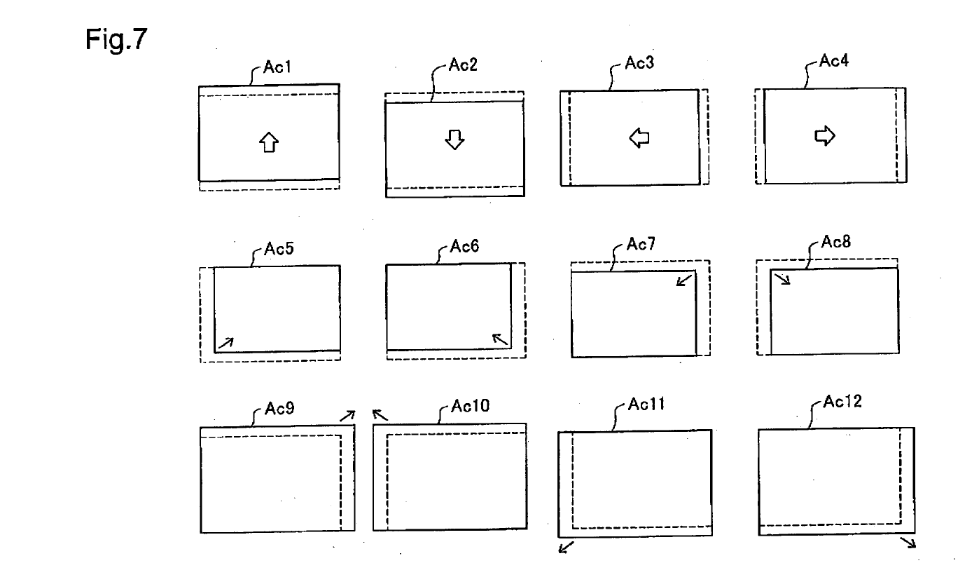

FIG. 7 illustrates candidate areas Ac1 to Ac12. The dashed lines in the figure represent the relative position of the candidate area Ac0 in relation to candidate areas Ac1 to Ac12. Candidate area Ac1 is an area displaced 1 pixel upward relative to candidate area Ac0 which is equivalent to the area of frame image data F3.

The “1 pixel” referred to here is 1 pixel in the pixel density of the frame image data, and is not 1 pixel in the pixel density of the still image data to be generated (4 times the pixel density of the frame image data). Thus, stated in terms of the units of pixels for the pixel density in the still image data, candidate area Ac1 is an area displaced upward 4 pixels relative to candidate area Ac0. The extent to which the candidate areas are displaced is illustrated disproportionately to the actual dimensions in FIG. 7 in order to facilitate the explanation of the relative positions between candidate area Ac0 and candidate areas Ac1 through Ac12.

Candidate area Ac2 is an area displaced 1 pixel down relative to candidate area Ac0. Candidate area Ac3 is an area displaced 1 pixel left relative to candidate area Ac0, and candidate area Ac4 is an area displaced 1 pixel right relative to candidate area Ac0. That is, candidate area Ac3 can be displaced 1 pixel to the right relative to candidate area Ac0 to overlap candidate area Ac0. Candidate area Ac2 can be displaced 1 pixel to the left relative to candidate area Ac0 to overlap candidate area Ac0. The hollow arrows in the figure indicate the directions in which candidate areas Ac1 through 4 are displaced relative to candidate area Ac0.

The area of candidate area Ac5 is 1 pixel short at the left end relative to candidate area Ac0 and ¾ pixel short at the bottom end. The aspect ratio of candidate area Ac5 is thus 3:4, the same as that of candidate area Ac0. That is, candidate area Ac5 is an area in which candidate area Ac0 is shrunk, where the apex at the upper right is the reference point.

The “1 pixel” referred to here is 1 pixel in the pixel density of the frame image data, and is not 1 pixel in the pixel density of the still image data to be generated. Thus, stated in terms of the units of pixels for the pixel density in the still image data, candidate area Ac5 is an area lacking 4 pixels at the left end relative to candidate area Ac0 and lacking 3 pixels at the bottom end.

Candidate area Ac6 is an area short 1 pixel at the right end relative to candidate area Ac0 and is short ¾ pixel at the bottom end. Candidate area Ac7 is an area short 1 pixel at the right end relative to candidate area Ac0 and is short ¾ pixel at the top end. Candidate area Ac8 is an area short 1 pixel at the left end relative to candidate area Ac0 and is short ¾ pixel at the top end. The aspect ratio of candidate areas Ac6 to 8 are 3:4 in the same manner as in candidate area Ac0. In the figure, the arrows in candidate areas Ac5 to 8 indicate the directions in which candidate areas Ac5 to 8 are shrunk relative to candidate area Ac0.

Candidate area Ac9 is an area expanded 1 pixel at the right end relative to candidate area Ac0 and expanded ¾ pixel at the top end. Candidate area Ac10 is an area expanded 1 pixel at the left end relative to candidate area Ac0 and expanded ¾ pixel at the top end. Candidate area Ac11 is an area expanded 1 pixel at the left end relative to candidate area Ac0 and expanded ¾ pixel at the bottom end. Candidate area Ac12 is an area expanded 1 pixel at the right end relative to candidate area Ac0 and expanded ¾ pixel at the bottom end.

The aspect ratio of these candidate areas Ac9 through 12 is 3:4 in the same way as in candidate area Ac0. The arrows near the outer periphery of candidate areas Ac9 through Ac12 indicate the directions in which the candidate areas Ac9 through Ac12 are expanded relative to candidate area Ac0. The angle diagonal to the angle indicated by these arrows is the reference point in the expansion or shrinkage of the candidate areas relative to candidate area Ac0.

Candidate areas Ac5 to Ac12 comprising the expansion or shrinkage of candidate area Ac0 as described above all have a rectangular aspect ratio of 3:4. It is thus possible to generate an image with the same aspect ratio as the motion pictures no matter which of the candidate areas is selected as the image generation area. The still image data generated in Step S8 in FIG. 2 is composed with a pixel density 4 times greater than that of frame image data F1 through F5. The image that is generated can thus be expressed as the aggregation of pixels of still image data through the expansion or shrinkage of the vertical dimensions in units equal to 1 the pixels of the frames of image data, as in candidate areas Ac5 through Ac12.

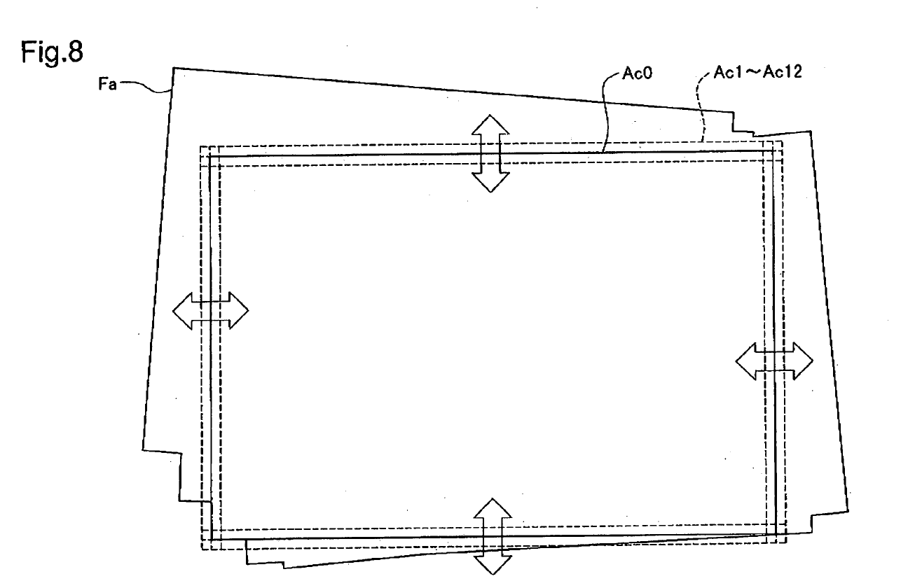

FIG. 8 illustrates the relative positions between candidate areas Ac0 to Ac12 and an area Fa which is an area comprising all the areas in which frame image data F1 to F5 are recorded. The area Fa in FIG. 8 is the convergence of areas included in any of the areas in the images of the frames of image data F1 through F5. In FIG. 8, candidate area Ac0 is indicated by solid lines, while candidate areas Ac1 through Ac12 are indicated by dashed lines. The hollow arrows indicate the directions in which candidate areas Ac1 through Ac12 move, expand, or shrink in relation to candidate area Ac0. In the first example, candidate areas Ac1 through Ac4 (which were areas shifted up, down, left, or right, as shown in FIG. 8, based on candidate area Ac0 (the area selected by the user in Step S2 of Figure)) and candidate areas Ac5 to Ac12 (which were expanded or shrunk areas) were set as the plurality of candidate areas. One candidate area is selected as the image generation area Ad from among these candidate areas Ac 1 through Ac12. An image close to the image desired by the user can thus be generated in the form of a still image.

For example, candidate area Ac1 is an area displaced 1 pixel upward relative to candidate area Ac0, and candidate are Ac2 is an area displaced 1 pixel down relative to candidate area Ac0. That is, candidate area Ac1 can be shifted 1 pixel down relative to candidate area Ac0 to overlap candidate area Ac0, and candidate area Ac2 can be shifted 1 pixel up relative to candidate area Ac0 to overlap candidate area Ac0. It is thus possible to select a desirable image generation area while respecting the image area designated by the user by preparing candidate areas in which the candidate area Ac0 (the image area indicated by the user) is shifted in mutually opposed directions.

Also, for example, candidate area Ac5 is an area in which candidate area Ac0 is shrunk using the apex on the upper right as the reference point. By contrast, candidate area Ac11 is an area in which candidate area Ac0 is expanded using the apex on the upper right as the reference point. In other words, candidate area Ac5 can be expanded using the apex at the top right as a reference point to overlap candidate area Ac0. Candidate area Ac11 can be shrunk using the apex at the top right as a reference point to overlap candidate area Ac0. It is thus possible to select a desirable image generation area while respecting the image area designated by the user by preparing candidate areas in which the candidate area Ac0 (the image area indicated by the user) is expanded or shrunk using the same reference point.

In Embodiment 1, the same number of candidate areas shifted in opposed directions based on candidate area Ac0 (one each in Embodiment 1) were used as candidate areas. A still image can thus be generated with an area in which an image of high pixel density is readily generated, being an area close to the image area desired by the user. Similarly, the same number of candidate areas comprising areas expanded or shrunk based on the same reference point with respect to candidate area Ac0 (one each in Embodiment 1) were set as candidate areas. A still image can thus be generated with an area in which an image of high pixel density is readily generated, being an area close to the image area desired by the user.

In Step S26 in FIG. 6, a candidate area for which the evaluation value E1 is to be estimated is selected from candidate areas Ac0 to Ac12. First, candidate area Ac0 equivalent to the image area of frame image data F3 is selected. Frame image data F3 is the frame image data with the instant which the user specified by keyboard 120 or mouse 130 during motion picture playback in Step S2 of FIG. 2.

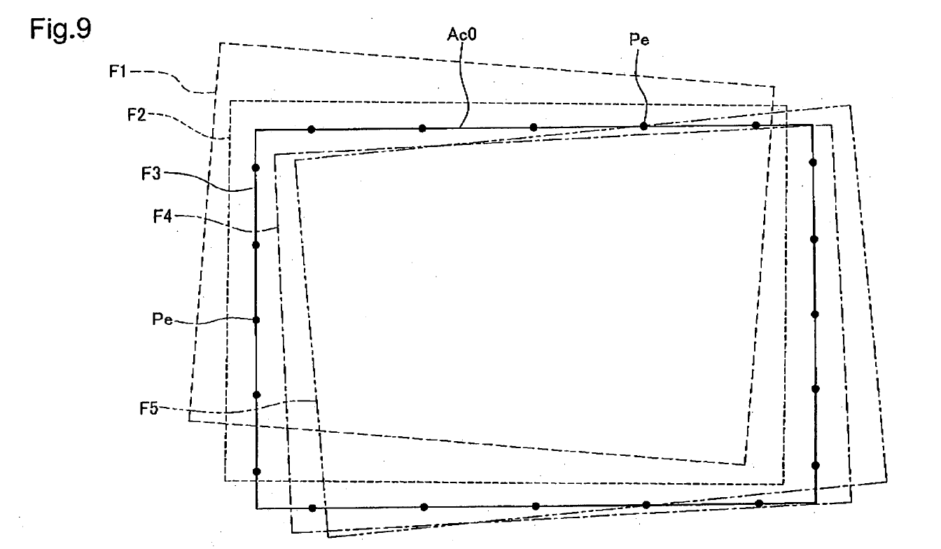

FIG. 9 illustrates the relationship between sample points Pe of candidate area Ac0 and the frame image data F1 through F5. Five sample points Pc are set on each side of candidate areas Ac0 to Ac12. Each sample point is set equidistantly within the sides, and the distance from the sample points at both ends to the sides is ½ the distance between the sample points.

In Step S28 of FIG. 6, the number of sample points Nᵢⱼₖ which are within each frame image data out of all sample points on the sides of the candidate area selected in Step S26. Here, i is an integer from 0 to 12 corresponding to candidate area Ac0 to Ac12, and j is an integer from 1 to 4 representing the four sides of the rectangular candidate areas, where j=1 means the left side, j=2 means the right side, j=3 means the top side, and j=4 means the bottom side. The symbol k is an integer from 1 to 5 corresponding to frame image data F1 through F5. In the present Specification, sample points which are within the area of the frame image data out of sample points set in relation to the candidate areas are referred to as “evaluation sample points.” When the process first reaches Step S28, the number Nᵢⱼₖ for the objects in the frame image data among the sample points on the left side of the candidate areas is first determined.

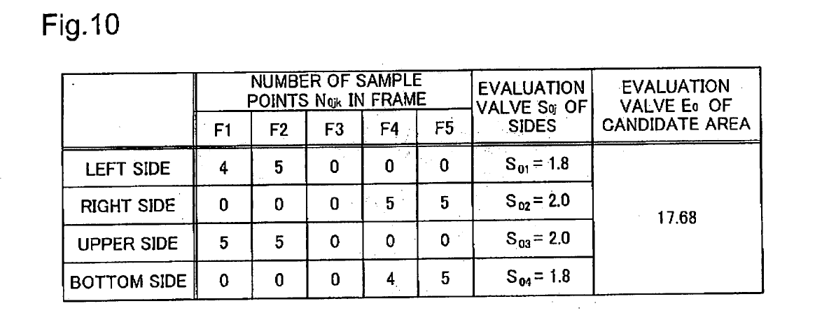

FIG. 10 illustrates the number Nᵢⱼₖ of sample points in the frame image data for candidate area Ac0, the evaluation values Sₒⱼ of the candidate area Ac0, and the evaluation value E₀ of candidate area Ac0. For example, in FIG. 9, four of the five sample points Pe on the left side of candidate area Ac0 are in the image area of frame image data F1 (indicated by the relatively rough dashed line). Thus, 4 is indicated in the “F1” column in the “left side” row in FIG. 10. Similarly, five of the sample points Pe on the left side of candidate area Ac0 are in frame image data F2 (indicated by relatively narrow dashed line). Thus, 5 is indicated in the “F2” column in the “left side” row in FIG. 10.

Because candidate area Ac0 is consistent with the frame image data F3, the sample points Pe on each side of candidate area Ac0 are on each side of the frame image data F3. When the sample points of a candidate area are on each side of frame image data, those sample points are regarded as “not” being in the frame image data. Thus, 0 is indicated in column “F3” in the “left side” row in FIG. 10. Because none of the sample points on the sides of the candidate area Ac0 are regarded as being in the frame image data F3, sample point numbers N₀₁₃, N₀₂₃, N₀₃₃, and N₀₄₃ are also 0 in the “right,” “upper,” and “bottom side” rows as well as in the “left side” row of column “F3” in FIG. 10.

As noted above, in Step S28 of FIG. 6, the number Nᵢⱼₖ of sample points on the sides of the candidate area selected in Step S26 which are also in frame image data is determined. That is, when the candidate area Ac0 is selected in Step S26, the values for all of the left, right, upper, and bottom side rows in each column F1 through F5 in FIG. 10 are determined for the candidate area Ac0. The values for the left side row of columns F1 through F5 in FIG. 10 are determined first.

In Step S30 of FIG. 6, the evaluation values Sᵢⱼ for the sides of the candidate areas are first determined. The evaluation values Sᵢⱼ for the sides are calculated by the following Equation (1). N_{ijA} is the total number of sample points set for the sides of the candidate areas. In Embodiment 1, N_{ijA} is 5 for all sides.

$${S}_{ij} = {\sum }_{k = 1}^{5} \{ \frac{{N}_{ijk}}{{N}_{ijA}} \} \qquad ( 1 )$$

With regard to the left side of candidate area Ac0, for example, as shown in FIG. 10, there are 4 sample points in frame image data F1, 5 sample points in frame image data F2, and 0 sample points in frame image data F3 through F5, so S₀₁ is 1.8. The other evaluation values S01 to S04 for the sides of candidate area Ac0 are given in the table in FIG. 10.

In Step S32 of FIG. 6, it is determined whether evaluation values Sᵢⱼ have been calculated for all the sides of the candidate area selected in Step S26. When the result is No because evaluation values Sᵢⱼ have not been calculated for all the sides of the candidate area, the process returns to Step S28. The number Nᵢⱼₖ for points in the frame image data is determined for each side for which no evaluation value Sᵢⱼ has been calculated. Steps S28 through S32 are repeated until evaluation values Sᵢⱼ have been calculated for all the sides of the candidate area selected in Step S26. The process proceeds to Step S34 once the results in Step S32 are determined to be Yes.

In Step S34, the evaluation value Ei for the candidate area Ac1 selected in Step S26 (i is the number designating the candidate area: i=0 to 12) is determined. The evaluation value Ei is calculated by the following Equation (2). St is the target evaluation value set in Step S22.

$${E}_{1} = {\sum }_{j = 1}^{4} {( {S}_{ij} - St )}^{2} \qquad ( 2 )$$

E₀ is 17.68 in the example shown in FIGS. 9 and 10. As will be evident from the form of Equation (2), the closer the evaluation values Sij of each side are to the target evaluation value St set in Step S22, the lower the evaluation value Ei of the candidate area Ac1. As will be evident from Equations (1) and (2), the evaluation value Ei is determined on the basis of the target evaluation value St and the number Nᵢⱼₖ for the sample points in the frame image data (evaluation sample points). Here, the number of evaluation sample points is determined by the overlap between the candidate area and the first images. The evaluation value Ei is thus determined on the basis of the target evaluation value St and the overlap between candidate areas and the first images.

In Step S36, it is determined whether the evaluation value Ei has been determined for all candidate areas Ac0 to Ac12. When the result is No because there are some candidate areas for which the evaluation value Ei has not been calculated, the process returns to Step S26, and the next candidate area is set from among the candidate areas for which no evaluation value Ei has been calculated. The process proceeds to Step S38 when the evaluation value Ei is calculated for all candidate areas Ac0 to Ac12.

In Step S38, the candidate area with the lowest evaluation value Ei is selected as the image generation area. That is, the candidate area in which the evaluation value Sᵢⱼ for each side is near the target evaluation value St most is selected as the image generation area. The process for determining the image generation area (Step S6 in FIG. 2) is thus concluded.

The function of calculating the evaluation values of the candidate areas and selecting one candidate area from among the plurality of candidate areas based on this evaluation value is managed by a candidate area selector 102f (see FIG. 1) which is a functional component of the CPU 102. The candidate area selector 102f is a functional component constituting part of the generation area determining component 102c which is a functional component of the CPU 102.

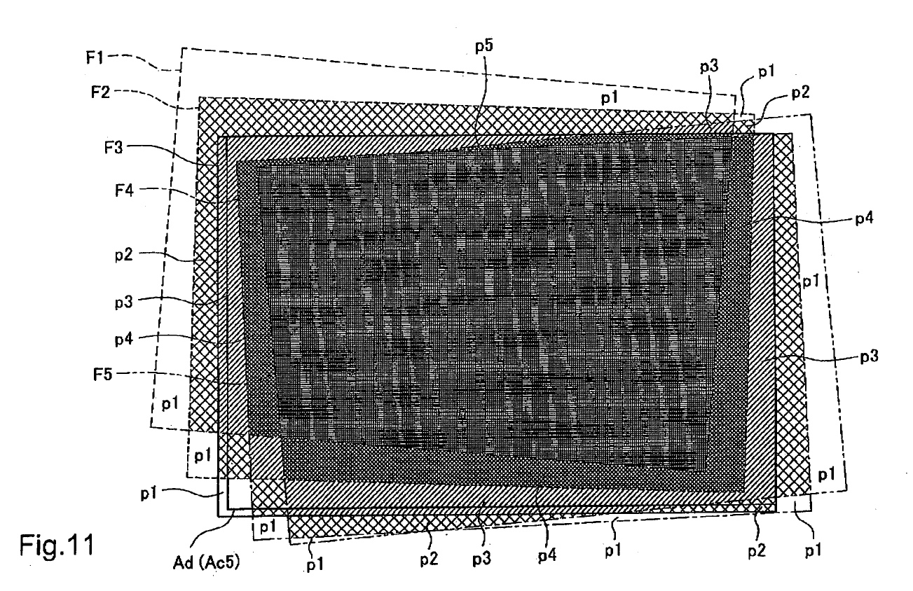

FIG. 11 illustrates the relationship between image generation area Ad and portions in which the frame image data F1 through F5 overlap. In FIG. 11, the portion p5 which is recorded in the frame image data F1 through F5 redundantly is indicated by fine vertical-horizontal cross-hatching, and the portion p4 which is recorded in four overlapping sets of frame image data is indicated by diagonal cross-hatching. The portion p3 which is recorded in three overlapping sets of frame image data is indicated by slanted hatching, and the portion p2 which is recorded in two sets of overlapping frame image data is represented by coarse cross-hatching.

The selection of the image generation area from among the candidate areas in the manner described above enables that a candidate area including the most sample points in the fame image data F1 through F5 is selected as the image generation area Ad.

The candidate area including the most sample points in the frame image data F1 through F5 includes the area from the areas of frame image data most. When such a candidate area is used as the image generation area, the tone levels of the pixels in the still image can be properly specified based on pixel values of many pixels in many frame image data when generating the still image described below.

In the example in FIG. 11, for example, candidate area Ac5 in which the lower end and left end are shrunk relative to candidate area Ac0 (equivalent to the area in frame image data F3) is selected as the image generation area Ad. In FIG. 11, the area of portions p5 and p4 are both contained in the image generation area Ad. The lower left part of portion p1 is contained in the image generation area Ad, but the rest of portion p1 is not contained in the image generation area. The lower left and upper right parts of portion p2 are contained in the image generation area Ad, but the rest of portion p2 is not contained in the image generation area Ad.

Candidate area Ac5 is assumed to be selected as the image generation area Ad for the convenience of explanation. This assumption therefore does not mean that candidate area Ac5 is selected according to the procedure in the flow charts based on the relationship between the sample points Pe and frame image data F1 through F5 in FIG. 5 or 9.

In Embodiment 1, evaluation values E1 were calculated for a limited number of candidate areas, and the image generation area was selected from the candidate areas based on those grades. It is therefore possible to determine an image generation area capable of properly specifying the tone levels of the pixels in the still image in a short time.

In Embodiment 1, candidate areas with areas displaced up, down, to the left, and to the right based on the candidate area Ac0 selected by the user in Step S2 of FIG. 2, and candidate areas with expanded or shrunk areas, were set as candidate areas. It is thus possible to generate an image close to the one desired by the user in the form of a still image.

A-4: Generation of Still Image Data

In Step S8 in FIG. 2, still image data is generated based on the frame image data F1 through F5 for the area determined in Step S6. The frame image data are data representing the image as a aggregation of pixels. The pixels have red (R), green (G), and blue (B) tone levels. That is, the pixels comprise data on RGB tone levels and data on their positions in the image of each set of frame image data.

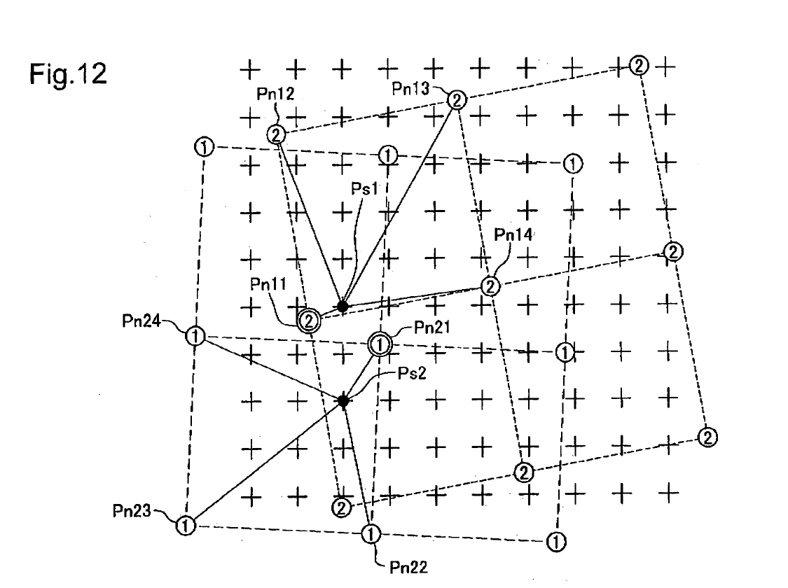

FIG. 12 illustrates a method for synthesizing an image of high pixel density from a plurality of images of low pixel density. The circled numeral 1's in the figure indicate the central positions of pixels in frame image data F1. The circled numeral 2's indicate the central positions of pixels in frame image data F2. The plus signs indicate the central positions of pixels in the still image data to be generated. To simplify the description, the frame image data is limited to F1 and F2. Only some of the pixels of frame image data F1 and F2 and of the still image data are shown in FIG. 12. The central positions of the pixels doe not reflect the actual relative positions of the image generation area determined in Step S6 or the area of pixels in the frame image data F1 and F2 shown in FIG. 5.

As noted above, the pixel density of the still image data is four times that of the frame image data. The intervals between the plus signs in FIG. 12 are thus ¼ the distance between the circled l's and between the circled 2's.

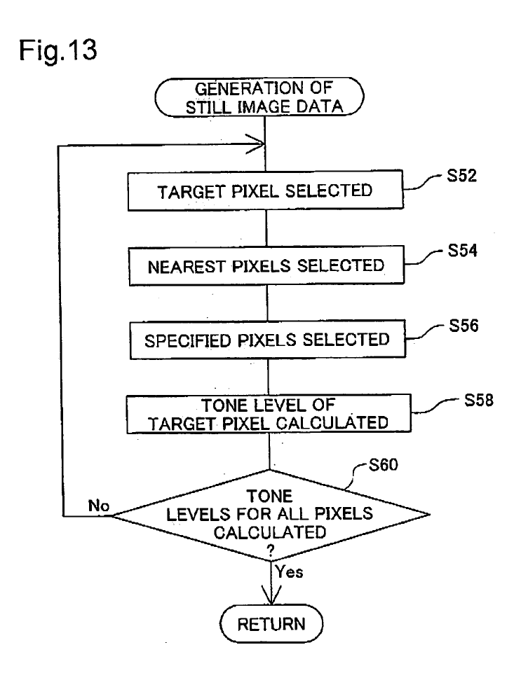

FIG. 13 is a flow chart of a procedure for determining the RGB tone levels for each pixel in an image of still image data based on the RGB tone levels for each pixel in the images of the frame image data. To generate still image data from the frame image data, the RGB tone levels must be determined for the positions shown by the plus signs in FIG. 12. This is done by the following procedure.

First, in Step S52, a target pixel for calculating the tone levels is specified. The target pixel for calculating the tone level in this case is Ps1 in FIG. 12. In Step S54, a pixel of which a central position is closest to the target pixel Ps1 among the pixels in frame image data F1 and F2 is specified. This pixel is referred to as the “nearest pixel.” In FIG. 12, the nearest pixel is Pn11 indicated by the double circled 2 among the pixels of frame image data F2.

After the nearest pixel Pn11 is specified, three neighboring pixels of the nearest pixel Pn11 are specified, which are pixels in the frame image data including the nearest pixel Pn11 and surround the target pixel Ps1 with nearest pixel Pn11. In this example, these pixels, including the nearest pixel, are referred to as the “specified pixels.” In the example in FIG. 12, the four pixels Pn11, Pn12, Pn13, and Pn14 at the top left among the pixels in frame image data F2 are the specified pixels.

Then, in Step S58, the tone level of the subject Ps1 is calculated based on the weighted average. Specifically, the tone level Vt of the target pixel Ps1 can be determined by the following Equation (3), where V1 to V4 are red, green, or blue tone levels of the specified pixels Pn11 through Pn4, respectively, and r1 through r4 are constants. Vt can be determined by Equation (3) from the red tone levels V1, V2, V3, and V4 of the specified pixels, where Vt is, for example, the red tone level of the target pixel Ps1. The tone levels of the target pixel are calculated for red, green, and blue.
Vt=(r1×v1)+(r2×v2)+(r3×v3)+(r4×v4) (3)

Here, r1 through r4 can be determined by Equations (4) through (7) below. Aa is the surface area of the rectangle surrounded by the four specified pixels Pn11 through Pn14. A1 is the area of the quadrangle composed of the target pixel Ps1 and the three specified pixels Pn12 through Pnl4 other than Pn 11. Similarly, A2 is area of the quadrangle composed of the target pixel Ps1 and the three specified pixels other than Pnl2. A3 is area of the quadrangle composed of the target pixel Ps1 and the three specified pixels other than Pnl3. A4 is area of the quadrangle composed of the target pixel Ps1 and the three specified pixels other than Pn14.
r1=A1/Aa (4)
r2=A2/Aa (5)
r3=A3/Aa (6)
r4=A4/Aa (7)

In Step S60 of FIG. 13, it is determined whether tone levels have been calculated for all the pixels of the still image data. The process returns to Step S52 when the result is No because there are pixels for which the tone level has not been calculated.

When the tone level is calculated for pixel Ps2 in FIG. 12, for example, the nearest pixel is Pn21 indicated by the double circled 1. The specified pixels are Pn21 through Pn24 in frame image data F1. The tone levels of pixel Ps2 can be calculated from the tone levels of the specified pixels Pn21 through Pn24 based on Equation (3) in the same manner as pixel Ps1.

In Step S60 of FIG. 13, the process is ended when the result is Yes because tone levels have been calculated for all pixels.

The above procedure can be carried out to generate still image data of relatively high pixel density from a plurality of frame image data of relatively low pixel density. Tone levels can be determined at values close to the actual color because the tone levels of the nearest pixel close to the target pixel for which the tone levels are calculated are most reflected, and the pixel values of other pixels near the nearest pixel are used for interpolation.

B. Embodiment 2

In Embodiment 1, as illustrated in FIG. 9, sample points Pe on the sides of a candidate area were set, and an evaluation value Ei for the candidate area was determined based on the number of sample points Pe included in frame image data F1 through F5. The image generation area was then determined from among the plurality of candidate area based on the evaluation value Ei. In Embodiment 2, the method for selecting a candidate area as the image generation area from the plurality of candidate areas is different than in Embodiment 1. The other points are the same as in Embodiment 1.

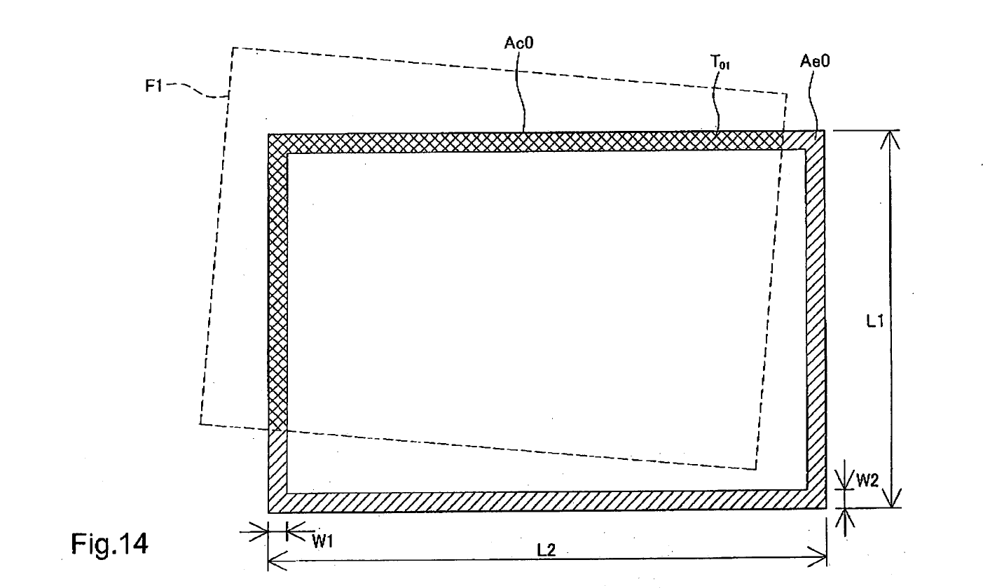

FIG. 14 illustrates an evaluation area Ae0 which is set inside candidate area Ac0 and near the perimeter of candidate area Ac0 in a certain width. In Embodiment 2, an evaluation area Aei (i is the number designating the candidate area: i=0 to 12) is set at a certain width near the outer periphery in a candidate area Ac1. Here, the width of the evaluation area Aei is 1/20 of the long side of the candidate area. In FIG. 14, the evaluation area Ae0 is the area indicated by the hatching and cross-hatching.

When determining the evaluation value Di of the candidate area Ac1 (i is the number designating the candidate area: i=0 to 12), the number of pixels Tᵢ₁ (i is the number designating the candidate area: i=0 to 12) in the area (represented by the cross-hatching in FIG. 14) included in the frame image data F1 within the evaluation area Aei is calculated. Here, the pixels counted for the evaluation area Aei are pixels in the frame image data F1.

Similarly, the number of pixels Ti₂ to Ti₅ in frame image data F2 through F5 in the portion included in frame image data F2 through F5 within the evaluation area Aei are calculated. The evaluation value Di of the candidate area is determined by Equation (8) below. Here, Ta is the number of pixels in the frame image data included in the evaluation area when the evaluation area is consistent with the area of the frame image data. Constants i and k are the same as in Embodiment 1. In the present Specification, the portion of the evaluation area Aei contained in the frame image data area is referred to as the “limited evaluation area.”

$${D}_{i} = {\sum }_{k = 1}^{5} \{ \frac{{T}_{ik}}{Ta} \} \qquad ( 8 )$$

The candidate area with the greatest Di is selected as the image generation area. This embodiment also allows candidate areas including many areas with several overlapping sets of frame image data to be selected as the image generation area. That is, in this embodiment, the image generation area is an area capable of generating high resolution still images.

C. Embodiment 3

In Embodiment 2, the evaluation value Di of the candidate areas Ac1 was determined based on the number of pixels in the area contained in the frame image data F1 within the evaluation area Aei. An image generation area was then determined from among the candidate areas Ac1 based on the evaluation value Di. In Embodiment 3, the image generation area is determined from among the candidate areas Ac1 based on the length Lcᵢₖ of sections contained in the frame image data within the sides of the candidate areas Ac1. The other points are the same as Embodiment 2. In the present Specification, the portion included in the frame image data area within the sides of the candidate areas Ac1 is referred to as the evaluation target portion.

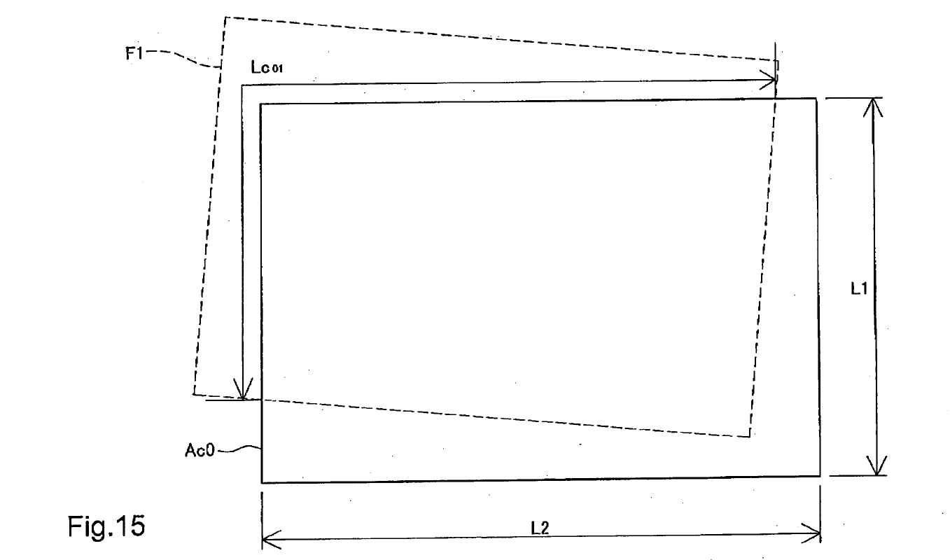

FIG. 15 illustrates the length Lc₀₁ of a portion contained in the area of the frame image data F1 within the four sides of candidate area Ac0. In Embodiment 3, the evaluation values Gi (i is the number designating the candidate area: i=0 to 12) of the candidate areas Ac1 are determined by Equation (9) below. Lcᵢₖ is the length of the portion contained in the area of frame image data within the 4 sides around candidate areas Ac1. The constants i and k are the same as in Embodiment 1. Lcᵢₖ corresponds to the “evaluation distance” in the “Means for Solving the Abovementioned Problems.” L1 is the length of the short side of the candidate areas, and L2 is the length of the long side.

$${G}_{i} = {\sum }_{k = 1}^{5} \{ \frac{{Lc}_{ik}}{( L1 + L2 ) \times 2} \} \qquad ( 9 )$$

The candidate area with the greatest Gi is selected as the image generation area. This embodiment allows a candidate area with more areas of several overlapping frame image data to be selected as the image generation area. That is, in this embodiment, an area capable of generating a high resolution still image can be used as the image generation area.

D. Embodiment 4

In Embodiment 4, the method for selecting a candidate area as the image generation area from a plurality of candidate areas is different than in Embodiment 1. The other points are the same as Embodiment 1.

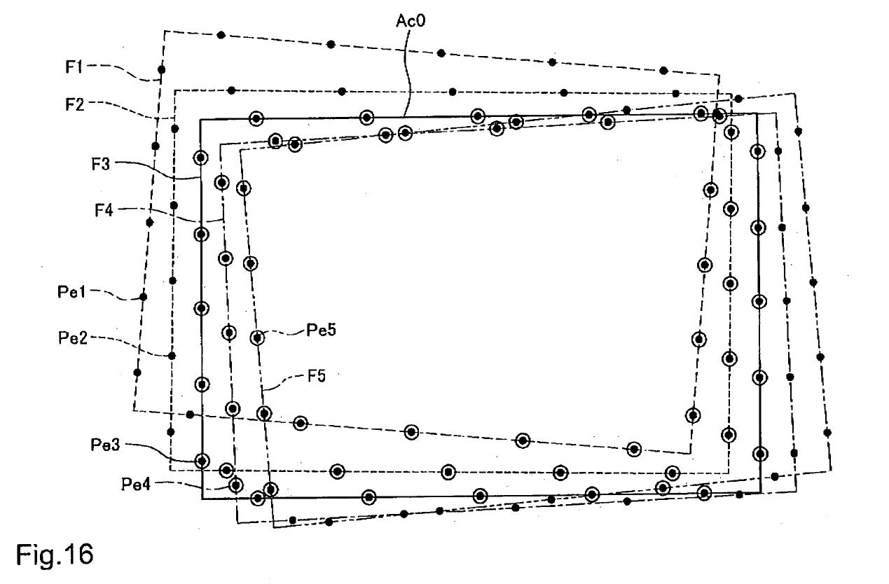

FIG. 16 illustrates sample points Pe1 through Pe5 set on the side of the image area of frame image data F1 through F5. The sample points are set equidistantly on the sides around areas in the frame image data F1 through F5. The distance from the sample points at either end within a side to the side are ½ the distance between the sample points.

In Embodiment 4, the evaluation value Hi (i is the number designating the candidate area: i=0 to 12) of the candidate areas Ac1 is the number of sample points Pe1 through Pe5 which the candidate areas include. In FIG. 16, the sample points Pe1 through Pe5 contained in the candidate area Ac0 are designated by rings around black circles. In the present Specification, the sample points on the sides of the frame image data which are included in the candidate areas are referred to as “evaluation sample points.” In the example in FIG. 16, 57 is the evaluation value for candidate area Ac0, that is, the number of sample points Pe1 through Pe5 in candidate area Ac0. In Embodiment 4, the sample points Pe1 through Pe5 on the sides of the candidate area are calculated as being in the candidate area.

In Embodiment 4, the candidate evaluation value with the greatest number of evaluation values Hi is used as the image generation area. This embodiment allows the candidate area containing more areas with more overlapping frame image data to be selected as the image generation area. That is, in this embodiment, an area capable of generating high resolution still images can be used as the image generation area.

E. Embodiment 5

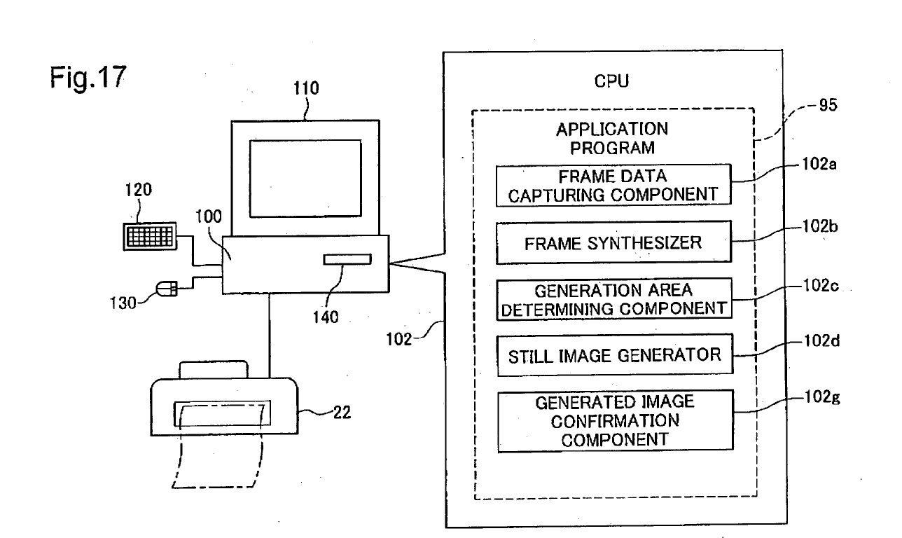

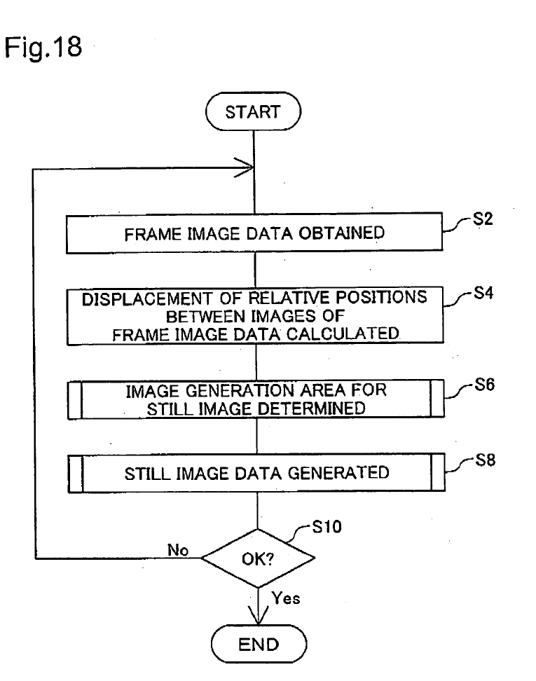

FIG. 17 is a schematic illustration of the structure of an image generator in Embodiment 5. FIG. 18 is a flow chart of a procedure for generating still image data representing a still image from a plurality of frame images in motion picture data in Embodiment 5. In Embodiment 5, after the still image data has been generated in Step S8 of FIG. 2, the user checks whether the generated image is good in Step S10. The functional component of the CPU 102 which carries out this function through the execution of the application program 95 is shown as the generated image confirmation component 102g in FIG. 17. In the printing system in Embodiment 5, the points other than the process in Step S10 are the same as in Embodiment 1, including the hardware structure.

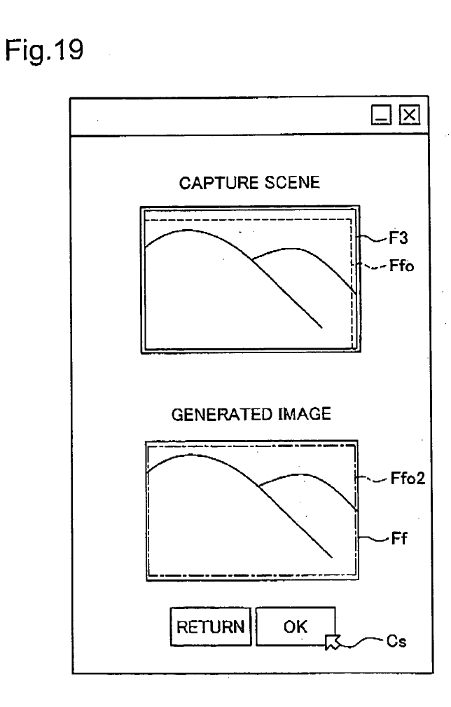

FIG. 19 is an illustration of a user interface display screen displayed on a display 110 in Step S10 in FIG. 18. The frame image data obtained in Step S2 of FIG. 18 (see FIG. 3) and the still image data Ff generated in Step S8 are displayed side by side by the generated image confirmation component 102g.

As illustrated in FIG. 19, the still image data Ff generated in Step S8 is displayed as the same size as the frame image data F3 on the user interface. In Embodiment 5, candidate area Ac7 has been selected as the image generation area (see FIG. 7). Candidate area Ac7 is an area smaller than the frame image data F3. Thus, when the still image data Ff generated with candidate area Ac7 is displayed on the display 110 on the same scale as the frame image data F3, the display will be smaller than the frame image data F3. In FIG. 19, the area of the still image data Ff relative to the area of the frame image data F3 is indicated by the dashed line as area Ffo.

The still image data Ff is enlarged more than the size that is displayed as the same scale as the frame image data F3 and is displayed as the same size as the frame image data F3 on the user interface display screen in FIG. 19. In FIG. 19, the area when the still image data Ff is displayed on the display 110 as the same scale as the frame image data F3 is represented by the dot-dash line as area Ffo2 on the still image data Ff.

This is an example of when still image data Ff is generated with an area smaller than the frame image data F3. However, when the still image data Ff is generated with an area greater than the frame image data F3 (such as candidate areas Ac9 to Ac12), the still image data Ff is shrunk smaller than when displayed as the same scale as the frame image data F3, and is displayed as the same size as the frame image data F3.

The still image data Ff is displayed as the same scale as the frame image data F3 when the still image data Ff is generated with an area the same size as the frame image data F3 (such as candidate areas Ac0 to Ac4). The still image data Ff is thus displayed as the same size as the frame image data F3.

This embodiment allows the user to easily compare the area of generated still image data Ff with the area of the image of the frame image data F3 selected by the user in Step S2.

When the comparison reveals the displayed still image data Ff to be good, the user can use the mouse 130 to click the cursor Cs on the OK button on the screen as shown in the lower part of FIG. 19. This concludes the process for generating still image data from the images in the frames of motion picture data. If, on the other hand, the comparison reveals the displayed still image data Ff to be unsuitable, the user can click the “Return” button shown at the bottom left side of FIG. 19. This will restart the process for generating the still image data from Step S2 in FIG. 18.

This embodiment allows the user to generate still image data having a desirable area after checking the contents of the still image data Ff that has been generated.

F. Variants

The invention is not limited to the preceding examples and embodiments, and can be worked in a variety of embodiments within the scope of the invention. The following variants are examples.

(1) In Embodiment 1, the image from the still image data that has been generated is composed of a pixel density four times greater than that of the frame image data. However, the pixel density of the still image data is not limited to that level and may be another pixel density. That is, the pixel density forming the still image that is generated may be higher than that of the original image. Here, “higher pixel density” has the following meaning. That is, in cases where the first images and the second image are of the same subject, the second image will have a “higher pixel density” than the first images when the number of pixels used by the second image to represent the subject is more than the number of pixels used by the first images to represent the subject.

(2) In Embodiment 1, one each of the candidate areas which had been shifted in mutually opposed directions based on candidate area Ac0 (which is an area equivalent to the area indicated by the user) were prepared. However, the number of these candidate areas is not limited to 1 each and can be any number of 1 or more. It is preferable, however, to prepare the same number of candidate areas shifted in mutually opposed directions.

In Embodiment 1, one each of the candidate areas comprising areas expanded or shrunk based on the same reference point with respect to candidate area Ac0 were set as candidate areas. However, the number of these candidate areas is not limited to 1 each and can be any number of 1 or more. It is preferable, however, to prepare the same number of candidate areas comprising areas expanded or shrunk based on the same reference point.

(3) In Embodiment 1, five sample points were set for each side of a candidate area. In Embodiment 4, five sample points were also set on the sides of the area of the image from the frame image data. However, the number of sample points is not limited to 5 and can be any number. The number preferably ranges from 5 to 21, however, and even more preferably from 9 to 17. The greater the number of sample points, the more detailed the evaluation of the candidate areas. However, the greater the number of sample points, the greater the calculations during the evaluation of the candidate areas.

In Embodiment 2, the width of the evaluation area Aei was 1/20 of the long side of the rectangular candidate area. However, the width of the evaluation area Aei can be another value. The width of the portion of the evaluation area Aei near the short side of the candidate area is preferably predetermined to be no more than ⅕ the length L2 of the long side of the candidate area, and the width W2 of the portion of the evaluation area Ae near the long side of the candidate area is preferably predetermined to be no more than ⅕ of the length of the short side of the candidate area. The width W1 of the evaluation area Ae near the short side is even more preferably predetermined to be no more than 1/10 of L2. The width W2 of the evaluation area Ae near the long side is even more preferably predetermined to be no more than 1/10 of the short side length L1 of the candidate area.

In Embodiment 2, the image generation area was selected from the candidate areas based on the extent of overlap between the evaluation area Ae0 set at a predetermined width near the periphery inside the candidate area Ac0 and the area of the frame image data. However, the evaluation area may be an area set to a certain width near the outer periphery outside the candidate area. That is, the evaluation area can be an area near the profile of the candidate area when selecting the image generation area based on the extent of the overlap between the evaluation area and the area of the frame image data.

“Near the profile of the candidate area” is defined as follows. The length of the longest line segment which can be included in the candidate area is referred to as a “first length.” At that time, when a certain point is within 20% or less of the first length from the candidate area profile, that point is regarded as being “near the profile of the candidate area.”

In Embodiment 1, sample points were set on each side of candidate areas. However, a plurality of sample points may be set near the profile of the candidate areas, and the image generation area can be selected from the candidate areas based on the number of sample points within the area of the frame image data.

The image generation area can also be selected based on the extent of the overlap between the candidate areas and the area of the image in the frames of image data. Such an embodiment allows the extent of the overlap to be assed in terms of the surface area of the overlapping sections. Based on the number of pixels in the frame image data which are included in the aforementioned overlapping area, the extent of the overlap can be evaluated to select the image generation area.

(4) In Embodiment 2, the evaluation value for the candidate areas was determined based on the number of pixels in the area included in the frame image data within evaluation area Aei. The number of pixels was counted based on the pixels in the frame image data. However, the number of pixels may also be counted based on the pixels in the image that is generated. The evaluation values of the candidate areas may thus be determined based on the number of pixels counted in this way. The evaluation values of the candidate areas may also be determined based on the surface area of the area included in the frame image data within the evaluation area Aei.

(5) The target numerical value when selecting the image generation area from the candidate areas in Embodiments 2 to 4 was not input by the user. That is, the numerical value corresponding to the target evaluation value St in Embodiment 1 was not input by the user. However, the user may input such numerical values in Embodiments 2 through 4. In Embodiment 2, the user may input a Dt value, which is the target Di, through the keyboard 120 or mouse 130, and the candidate area with the evaluation value Di having the least difference from the Dt may be selected as the image generation area. Similarly, in Embodiment 3 or 4, the user may input the Gt value, which is the target Gi value, and the Ht value, which is the target Hi value, and the candidate area with the evaluation values Gi and Hi having the least difference from them may be selected as the image generation area. These embodiments allow the user to control the size and resolution of the image that is generated.

For example, when a candidate area comprising a significant reduction of candidate area Ac0 is set in Embodiment 2, the candidate area will be smaller than the area of the frame image data F1 through F5, and a greater proportion of parts of the evaluation area Ac1 is thus easier to include in the area of the frame image data F1 through F5. Such candidate areas therefore have a greater Di value, making it easier to select an image generation area. However, embodiments in which the user inputs the Dt, which is the target Di, and selects the candidate area having a Di with the least difference from the Dt as the image generation area can prevent candidate areas with low surface area from always being selected as the image generation area. The same is true of Embodiment 3.

When a candidate area comprising a greatly expanded candidate area Ac0 is set in Embodiment 4, the candidate area will be greater than the area of the frame image data F1 through F5, making it easier for such candidate areas to include more sample points Pe1 through Pe5. Such candidate areas will therefore have a greater Hi value, making it easier to select the image generation area. However, embodiments in which the user inputs the Ht, which is the target Hi, and selects the candidate area having a Hi with the least difference from the Ht as the image generation area can prevent candidate areas with large surface area from always being selected as the image generation area.

In Embodiment 1, there were five sample points set on each of the long and short sides of the candidate areas. The target evaluation value St was thus only one of 1 to 5. However, the number of sample points set on the sides of the candidate areas can be any number. When a different number of sample points are set on the short and long sides of the candidate areas, target evaluation values St1 and St2 can be set for the short and long sides, respectively, and the evaluation values of the candidate areas can be calculated based on the target evaluation values St1 and St2 and deviation in the evaluation values Sᵢⱼ between the sides.

(6) In Embodiment 1, the specified pixels were the pixels included in the same frame image data. However, the specified pixels are not limited to the area in the same frame image data. That is, the specified pixels can be any pixels near the target pixel. Here, “near the target pixel” refers to the range included in a circle having a radius twice as long as the width of the pixels in the frame image data based on the target pixel. The specified pixels are preferably the 3 or 4 pixels nearest the target pixel.

(7) In the above examples, the shape of the area of the pixels in the still image data that is generated and the shape of the area of the pixels in the frame image data were similar. However, the area of the pixels in the still image data that is generated can be any shape. For example, the user can indicate or select the shape using the keyboard 120 or mouse 130. The candidate areas can thus be areas of the indicated shape which have been shifted vertically or laterally, or expanded or shrunk areas.

(8) In the above examples, the pixels in the frame image data had red, green, and blue tone levels. However, the pixels of the frame image data can have tone levels of other combinations of colors, such as cyan, magenta, and yellow.

(9) In Embodiment 5, the frame image data F3 obtained from the motion pictures and the still image data Ff that is generated were displayed on the display 110 (see FIG. 19). However, the frame image data F3 obtained from the motion pictures and the still image data Ff that is generated can be printed on a printer 22. Such an embodiment allows the user to compare the image area of the frame image data F3 and the image area of the still image data Ff that is generated.

That is, a printing system generating high resolution image data can output the low resolution image data, which is the starting material for generating high resolution image data, and high resolution image data generated from the low resolution image data by an output component capable of outputting image data in any form. The low resolution image data and the high resolution image data are preferably output in the same size.

(10) In the above examples, the evaluation value for the candidate areas was determined based on the number of sample points or on the length of the portion included in the frame image data within the sides of the candidate areas Ac1. However, the evaluation value for the candidate areas can be determined by other methods. The evaluation value for the candidate areas may be determined based on (i) the extent of the overlap between the candidate areas and the plurality of first images, and (ii) the target value representing the extent of the overlap between the image generation area and the plurality of first images. The evaluation values may be determined based on the deviation between the indicated value representing the extent of overlap between the candidate area and plurality of frame images (such as the evaluation value Sᵢⱼ on the sides of the candidate area in Embodiment 1) and the target value (such as the target evaluation value St in Embodiment 1).

(11) In the above examples, part of the structure realized by hardware can be replaced by software (computer programs), and conversely part of the structure realized by software can be replaced by hardware. For example, the process involving the use of the frame data capturing component and the still image generator in FIG. 1 can be done by a hardware circuit.
(12) Computer programs for running the above functions can be provided in the form of recordings on computer-readable recording media such as floppy disks and CD-ROMs. The host computer can read computer programs from the recording media and transfer them to an internal memory device or external memory device. Alternatively, computer programs may be provided to the host computer from a program provider through a communications circuit. When computer program functions are executed, computer programs stored in internal memory devices may be run by the microprocessor of the host computer. Computer programs recorded on recording media may also be directly run by the host computer.

(13) In the present Specification, the concept of a host computer includes hardware devices and operating systems, and means hardware devices operated under the control of an operating system. Computer programs allow the functions of the aforementioned components to be run by such a host computer. Some of the aforementioned functions may be run by an operating system instead of application programs.

(14) In the present invention, “computer-readable recording media” is not limited to portable recording media such as floppy disks and CD-ROMs, but also includes internal memory devices in computers, such as RAM or ROM, and external memory devices secured to computers, such as hard discs.

(15) The Program product may be realized as many aspects. For example:
(i) Computer readable medium, for example the flexible disks, the optical disk, or the semiconductor memories;
(ii) Data signals, which comprise a computer program and are embodied inside a carrier wave;
(iii) Computer including the computer readable medium, for example the magnetic disks or the semiconductor memories; and
(iv) Computer temporally storing the computer program in the memory through the data transferring means.

(16) While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

1. A method for generating an image, comprising:
(a) preparing a plurality of first images each of which includes a portion where a same recorded subject is recorded;
(b) determining an image generation area for generating a second image in which a density of pixels forming image is higher than that of the first images, based on a overlap between the plurality of first images; and
(c) generating the second imxage in the image generation area from the plurality of first images.

2. A method for generating an image according to claim 1, wherein
the determination of the image generation area is executed so that an overlapping index value representing an extent of overlap between the plurality of first images and the image generation area is closest to a predetermined target level on a predetermined condition.

3. A method for generating an image according to claim 1, wherein
the determination of the image generation area comprises:
(b1) preparing a plurality of candidate areas included in a sum area, the sum area being sum of areas in which first images are recorded; and
(b2) selecting one of the candidate areas as the image generation area from among the plurality of candidate areas, based on an evaluation value for each of the candidate areas which is determined based on overlaps between the plurality of first images and the candidate area.

4. A method for generating an image according to claim 3, wherein
the selection of the candidate area comprises
determining the evaluation values for the candidate areas based on relative positions between the candidate areas and the first images.

5. A method for generating an image according to claim 3, wherein
the selection of the candidate area comprises determining the evaluation value based on numbers of pixels in the first images included in portions where the candidate area and the first images overlap.

6. A method for generating an image according to claim 3, wherein
the selection of the candidate area comprises determining the evaluation value for each of the candidate areas, wherein
the determination of the evaluation value for one of the candidate areas comprises:
(b3) determining an evaluation target portion, the evaluation target portion being a portion of a profile of a target candidate area for which the evaluation value is being determined and being included in an area of one of the plurality of first images; and
(b4) determining the evaluation value for the target candidate area based on lengths of the evaluation target portions for the plurality of first images.

7. A method for generating an image according to claim 3, wherein
the selection of the candidate area comprises:
(b3) setting sample points on a profile of each of the candidate areas; and
(b4) determining the evaluation values for the candidate areas based on the sample points, wherein
the determination of the evaluation value for one of candidate areas comprises:
(b5) determining evaluation sample points among the sample points of a target candidate area for which the evaluation value is being determined, the evaluation sample points being sample points included in an area of one of the plurality of first images; and
(b6) determining the evaluation value for the target candidate area based on a number of the evaluation sample points of the plurality of first images.

8. A method for generating an image according to claim 3, wherein
the selection of the candidate area comprises:
(b3) setting sample points on a profile of each of the first images; and
(b4) determining the evaluation values for the candidate areas based on the sample points, wherein
the determination of the evaluation value for one of candidate areas comprises:
(b5) determining evaluation sample points among the sample points of one of the first images, the evaluation sample points being sample points included in a target candidate area for which the evaluation value is being determined; and
(b6) determining the evaluation value for the target candidate area based on numbers of the evaluation sample points of the plurality of first images.

9. A method for generating an image according to claim 3, wherein
the selection of the candidate area comprises:
(b3) setting evaluation areas having a certain width near profiles of the candidate areas; and
(b4) determining the evaluation values for the candidate areas based on the evaluation areas, wherein
the determination of the evaluation value for one of candidate areas comprises:
(b5) determining a limited evaluation area, the limited evaluation area being a portion of a target candidate area for which the evaluation values is being determined, being included in an area of one of the plurality of first images; and
(b6) determining the evaluation value for the target candidate area based on a total number of pixels included in the limited evaluation area of the plurality of first images.

10. A method for generating an image according to claim 3, wherein
the selection of the candidate area comprises:
(b3) setting sample points near profiles of the candidate areas; and
(b4) determining the evaluation values for the candidate areas based on the sample points, wherein
the determination of the evaluation value for one of candidate areas comprises:
(b5) determining evaluation sample points among the sample points of a target candidate area for which the evaluation value is being determined, the evaluation sample points being sample points included in an area of one of the plurality of first images; and
(b6) determining the evaluation value for the target candidate area based on a number of evaluation sample points for the plurality of first images.

11. A method for generating an image according to claim 3, wherein
the preparation of the plurality of candidate areas comprises:
(b7) setting a first candidate area included in the sum area being sum of areas in which first images are recorded; and
(b8) preparing:
a second candidate area, which is an area included in the sum area being sum of areas in which first images are recorded, and which is to conform to the first candidate area by being displaced a certain extent in a first direction, and
a third candidate area, which is an area included in the sum area being sum of areas in which first images are recorded, and which is to conform to the first candidate area by being displaced a certain extent in a direction opposite the first direction.

12. A method for generating an image according to claim 3, wherein
the preparation of the plurality of candidate areas comprises:
(b7) setting a first candidate area included in the sum area being sum of areas in which first images are recorded; and
(b8) preparing:
a second candidate area, which is an area included in the sum area being sum of areas in which first images are recorded, and which is to conform to the first candidate area by being shrunk around a certain fixed point, and
a third candidate area, which is an area included in the sum area being sum of areas in which first images are recorded, and which is to conform to the first candidate area by being magnified around a certain fixed point.

13. A method for generating an image according to claim 12, further comprising:
(d) outputting at least one of the plurality of first images through an output device; and
(e) outputting the second image through the output device in a same size as the first image output.

14. A method for generating an image according to claim 1, further comprising:
(f) calculating relative positions between the plurality of first images based on the portions where the same recorded subject is recorded, wherein
each of pixels of the plurality of first images have a tone level, and
the generation of the second image comprises:
(c1) selecting, from pixels of the second image, a target pixel for calculating the tone level;
(c2) selecting, from the pixels of the plurality of first images, a plurality of specified pixels located in a certain range near the target pixel when the pixels of the plurality of first images are supposed to be arranged according to the relative positions and pixels of the second image are furthermore supposed to be arranged in the image generation area; and
(c3) calculating tone level of the target pixel based on a weighted average of tone levels of the specified pixels.

15. An image-generating device, comprising:
an imaging component configured to prepare a plurality of first images each of which includes a portion where a same recorded subject is recorded;
a generation area determination component configured to determine an image generation area for generating a second image in which a density of pixels forming image is higher than that of the first images, based on a overlap between the plurality of first images; and
an image-generating component configured to generate the second image in the image generation area from the plurality of first images.

16. An image-generating device according to claim 15, wherein
the generation area determination component determines the image generation area so that an overlapping index value representing an extent of overlap between the plurality of first images and the image generation area is closest to a predetermined target level on a predetermined condition.

17. An image-generating device according to claim 15, wherein
the generation area determination component comprises:
a candidate area generation component configured to prepare a plurality of candidate areas included in a sum area, the sum area being sum of areas in which first images are recorded; and
a candidate area selection component configured to select one of the candidate areas as the image generation area from among the plurality of candidate areas, based on an evaluation value for each of the candidate areas which is determined based on overlaps between the plurality of first images and the candidate area.

18. An image-generating device according to claim 17, wherein
the candidate area selection component determines the evaluation values for the candidate areas based on relative positions between the candidate areas and the first images.

19. An image-generating device according to claim 17, wherein
the candidate area selection component determines the evaluation value based on numbers of pixels in the first images included in portions where the candidate area and the first images overlap.

20. An image-generating device according to claim 17, wherein
the candidate area selection component determines the evaluation value for each of the candidate areas, and
when determining the evaluation value for one of the candidate areas,
determines an evaluation target portion, the evaluation target portion being a portion of a profile of a target candidate area for which the evaluation value is being determined and being included in an area of one of the plurality of first images; and
determines the evaluation value for the target candidate area based on lengths of the evaluation target portions for the plurality of first images.

21. An image-generating device according to claim 17, wherein
the candidate area selection component
determines the evaluation values for the candidate areas based on sample points set on a profile of each of the candidate areas, and
when determining the evaluation value for one of candidate areas,
determines evaluation sample points among the sample points of a target candidate area for which the evaluation value is being determined, the evaluation sample points being sample points included in an area of one of the plurality of first images; and
determines the evaluation value for the target candidate area based on a number of the evaluation sample points of the plurality of first images.

22. An image-generating device according to claim 17, wherein
the candidate area selection component
determines the evaluation values for the candidate areas based on sample points set on a profile of each of the first images, and
when determining the evaluation value for one of candidate areas,
determines evaluation sample points among the sample points of one of the first images, the evaluation sample points being sample points included in a target candidate area for which the evaluation value is being determined; and
determines the evaluation value for the target candidate area based on numbers of the evaluation sample points of the plurality of first images.

23. An image-generating device according to claim 17, wherein
the candidate area selection component
determines the evaluation values for the candidate areas based on evaluation areas set near profiles of the candidate areas with a certain width, and
when determining the evaluation value for one of candidate areas,
determines a limited evaluation area, the limited evaluation area being a portion of a target candidate area for which the evaluation values is being determined, being included in an area of one of the plurality of first images; and
determines the evaluation value for the target candidate area based on a total number of pixels included in the limited evaluation area of the plurality of first images.

24. An image-generating device according to claim 17, wherein
the candidate area selection component
determines the evaluation values for the candidate areas based on sample points set near profiles of the candidate areas, and
when determining the evaluation value for one of candidate areas,
determines evaluation sample points among the sample points of a target candidate area for which the evaluation value is being determined, the evaluation sample points being sample points included in an area of one of the plurality of first images; and
determines the evaluation value for the target candidate area based on a number of evaluation sample points for the plurality of first images.

25. An image-generating device according to claim 17, wherein
the generation area determination component
sets a first candidate area included in the sum area being sum of areas in which first images are recorded; and
prepares:
a second candidate area, which is an area included in the sum area being sum of areas in which first images are recorded, and which is to conform to the first candidate area by being displaced a certain extent in a first direction, and
a third candidate area, which is an area included in the sum area being sum of areas in which first images are recorded, and which is to conform to the first candidate area by being displaced a certain extent in a direction opposite the first direction.

26. An image-generating device according to claim 17, wherein
the generation area determination component
sets a first candidate area included in the sum area being sum of areas in which first images are recorded; and
prepares:
a second candidate area, which is an area included in the sum area being sum of areas in which first images are recorded, and which is to conform to the first candidate area by being shrunk around a certain fixed point, and
a third candidate area, which is an area included in the sum area being sum of areas in which first images are recorded, and which is to conform to the first candidate area by being magnified around a certain fixed point.

27. An image-generating device according to claim 26, further comprising
a generated image output component configured to
output at least one of the plurality of first images through an output device; and
output the second image through the output device in a same size as the first image output.

28. An image-generating device according to claim 15, further comprising
a relative position calculating component configured to calculates relative positions between the plurality of first images based on the portions where the same recorded subject is recorded, wherein
each of pixels of the plurality of first images have a tone level, and
the image-generating component
selects, from pixels of the second image, a target pixel for calculating the tone level;
selects, from the pixels of the plurality of first images, a plurality of specified pixels located in a certain range near the target pixel when the pixels of the plurality of first images are supposed to be arranged according to the relative positions and pixels of the second image are furthermore supposed to be arranged in the image generation area; and
calculates tone level of the target pixel based on a weighted average of tone levels of the specified pixels.

29. A computer program product for generating an image, comprising:
a computer-readable recording medium; and
a computer program stored on the computer-readable recording medium, wherein
the computer program comprises
a first portion for preparing a plurality of first images each of which includes a portion where a same recorded subject is recorded;
a second portion for determining an image generation area for generating a second image in which a density of pixels forming image is higher than that of the first images, based on a overlap between the plurality of first images; and
a third portion for generating the second image in the image generation area from the plurality of first images.
